(19) United States
(12) Patent Application Publication
(10) Pub. No.: US 2008/0164098 A1
(43) Pub. Date: Jul. 10, 2008

(54) METHOD AND APPARATUS FOR CONTROLLING HUMAN SCENT WHILE DEER HUNTING

(76) Inventors: JOHN E. GROVES, NAPLES, FL (US); JOHN W. GROVES, DAVENPORT, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 11/619,906

(22) Filed: Jan. 4, 2007

(51) Int. Cl. A01M 31/02

(52) U.S. Cl. 182/129; 182/187

(57) ABSTRACT

A method and apparatus for controlling human scent from hunters in tree stands. The apparatus in its preferred form is a portable tree stand in combination with a heat shield and a heater holder selectively attached to the bottom of the tree stand foot platform to define a plenum and a portable heater holder. In operation the heater, such as a propane heater, heats the air in the plenum which expands and rises like all warm air and carries with it the human scent which is then directed up past the body and away.

### FIELD OF THE INVENTION

The present invention relates to a combination portable tree stand, heater and scent removal device to allow the hunter to have a tree stand and also eliminate near ground scent of the human body.

### BACKGROUND OF THE INVENTION

Deer, and especially white tail deer, are known to be some of the most elusive game animals hunted. While elusiveness is especially true for white tail deer, it is also true for other trophy animals such as elk, bear, etc. Some animals that are capable of preying upon humans, involve personal safety risk if human scent is detected. Among of the reasons many of these animals are so elusive is that they rely not only on sight but a highly developed sense of smell. Their ability to smell and detect odors, including human odor, far exceeds the capability of the human nose. As a result, one of the primary defense mechanisms of, for example the while tail deer, is the detection of what is to them unnatural scent. The use of scent to detect danger by the deer means that effective hunting must take advantage of prevailing winds, and must to the extent possible avoid unnatural scents including human scent, as the hunt is pursued.

As a result of the ever increasing popularity of white tail deer hunting, many products have come on the market that make human scent detection more difficult by either attempting to reduce human odors or by masking of a them with things such as more naturally occurring scents like fox urine, etc.

In the area of eliminating human scent some specialized clothing and clothing material having scent-absorbing features have in recent times been popular, see for example, U.S. Pat. Nos. 5,539,930; 5,585,107; 5,678,247; 5,891,391; and 5,706,535. Such specialized scent eliminating clothing has some popularity but it is expensive and sometimes is simply not comfortable to wear. As a result, many hunters simply prefer wearing traditional clothing and hunting with constant awareness of prevailing winds and making sure that one locates himself/herself downwind of the animals pursued.

In the area of masking scents, all sorts of naturally occurring scents and scent deodorizers are sold. However these too have their limits in that they eventually wear off or at least are reduced to the point where the game animals can detect the underlying human odor.

There have been some attempts to take advantage of naturally occurring updrafts, and in this regard, see for example U.S. Reissue Pat. 38,231. U.S. RE 38,231 of Aug. 26, 2003 discloses a scent free wildlife blind with a tube that comes out of the top of the blind and extends up approximately 30 feet above the ground. The air passing across the open end of the tube creates an updraft that draws the human scent upward and vents it out. While in theory this might work, it is a cumbersome device and may well create insufficient updraft to effectively eliminate the human odor.

There are some devices that use heat for warming a hunter, see Knopps, U.S. Pat. No. 3,024,782 which shows a heating device that basically is installed inside of a seat bucket. U.S. Pat. No. 6,705,308 of Mar. 16, 2004 also shows a personal heating device that is a container of the seat type variety. However the devices of both U.S. Pat. Nos. 3,024,782 and 6,705,308 are designed to sit on the ground. They are not scent removal systems, but heaters.

For nearly as long as deer hunting has been popular in the United States of America, it has been known that one of the most effective ways to hunt deer is to be elevated, for example, in a tree stand. For reasons not known, deer seldom look up to find danger. This known tendency of deer has resulted in hunting from tree stands as being one of the most successful methods of deer hunting, especially for archery where the requirement of being quite close to the animal is essential.

There is therefore a continuing need to provide improved hunting methods, techniques and devices which control human scent and at the same time allow the hunter to wear conventional clothing and be elevated in a tree stand. Accordingly it is a primary objective of the present invention to fulfill this continuing need. This primary need is fulfilled by development of a system which allows use of a portable tree stand, and at the same time warms the hunter and creates an updraft which carries human scent up and away.

### BRIEF SUMMARY OF THE INVENTION

A method and apparatus for controlling human scent emanating from hunters in tree stands. The apparatus in its preferred form is a portable tree stand in combination with a heat shield and a heater holder selectively attached to the bottom of the tree stand's foot platform to define a plenum as well as a portable heater holder. In operation the heater, such as a propane heater, heats the air in the plenum which expands and rises like all warm air and carries with it the human scent which is then directed up past the body and away. This aids the hunter and eliminates some risk of viscious animal attacks.

### BRIEF DESCRIPTION OF THE DRAWINGS

FIG. 1 is a perspective view of the system of the present invention in use to show how it creates updrafts.

FIG. 2 is a plan view alone line 2-2 of the plenum or heat shield/heater holder looking down through the foot support grate.

FIG. 3 is an exploded view of the heat shield/heater holder of one embodiment.

FIG. 4 shows how the heat shield/heater holder attaches to the foot platform of a tree stand.

FIG. 5 shows an angled metal sheet plenum in perspective views.

### DETAILED DESCRIPTION OF THE PREFERRED EMBODIMENT

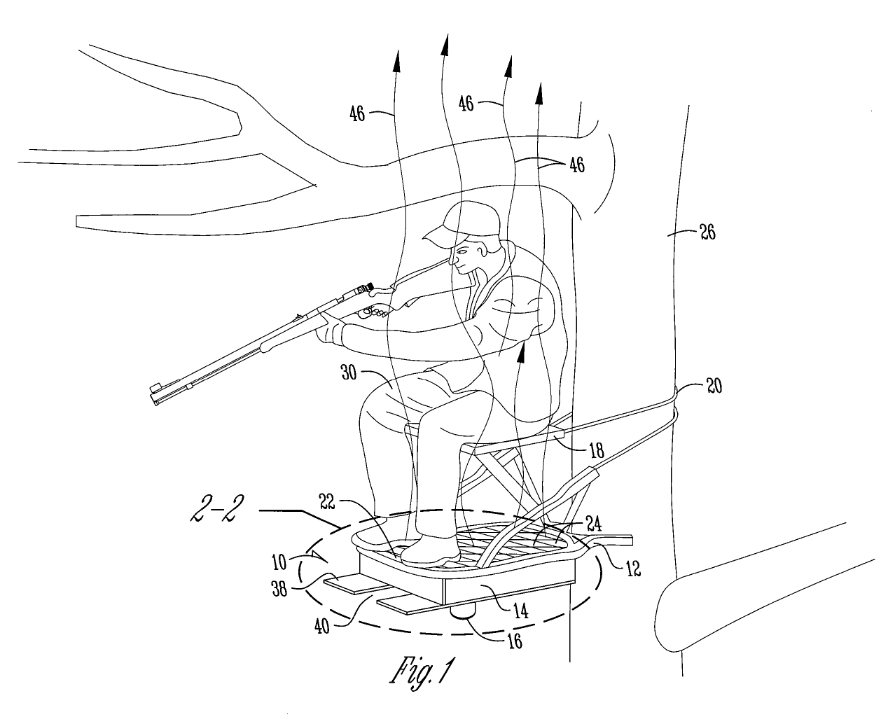

FIG. 1 shows the device in question in combination with a portable tree stand, in perspective view. The device 10 is the combination of a conventional portable tree stand 12 and a heat shield or plenum chamber forming device 14 and the heater 16.

Tree stand 12 is comprised of a seat 18 attached to a tree 26 via cable 20 with a foot support 22 having vents 24 also attached to the tree 26. As explained below, the foot support 22 also functions as a heat grate.

Tree stand 12 is secured to the tree 26 by detachable straps or cables 18, and 28. Hunter 30 sits in the tree stand 12 with his feet on foot support 22. Attached by fasteners or brackets 32 and threaded bolts 33, washers 33a and nuts 33b to foot support 22 is a combination heat shield or plenum chamber formed by walls 34, 35 and 36 joined by bottom wall 38. Bottom wall 38 has a slot opening 40. Front wall 41 has shelf 42 with hole 43 through which heater 16 can be inserted. It's weight holds shelf 42 in place.

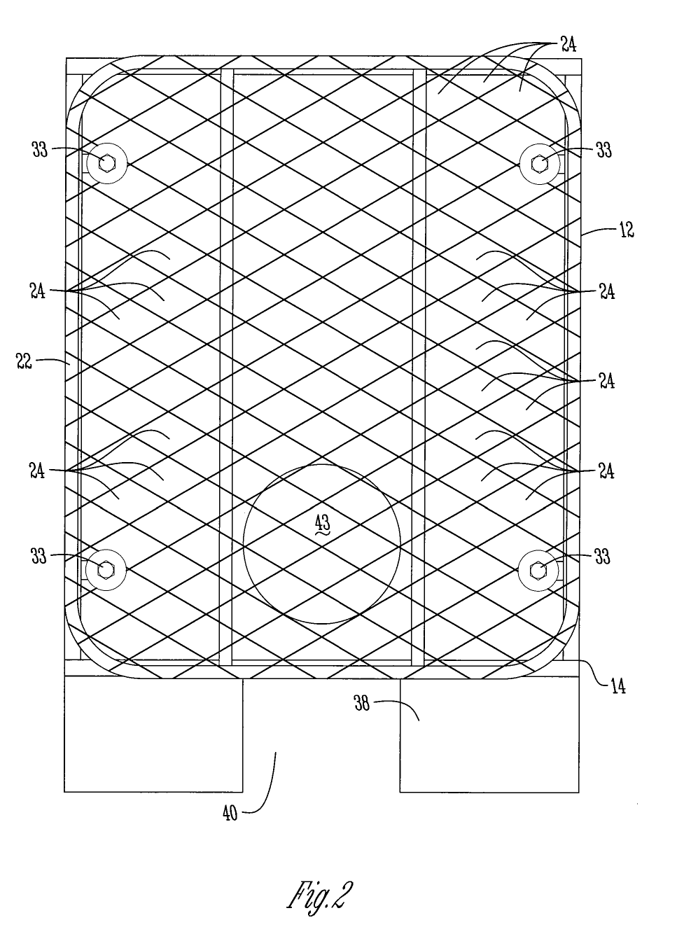

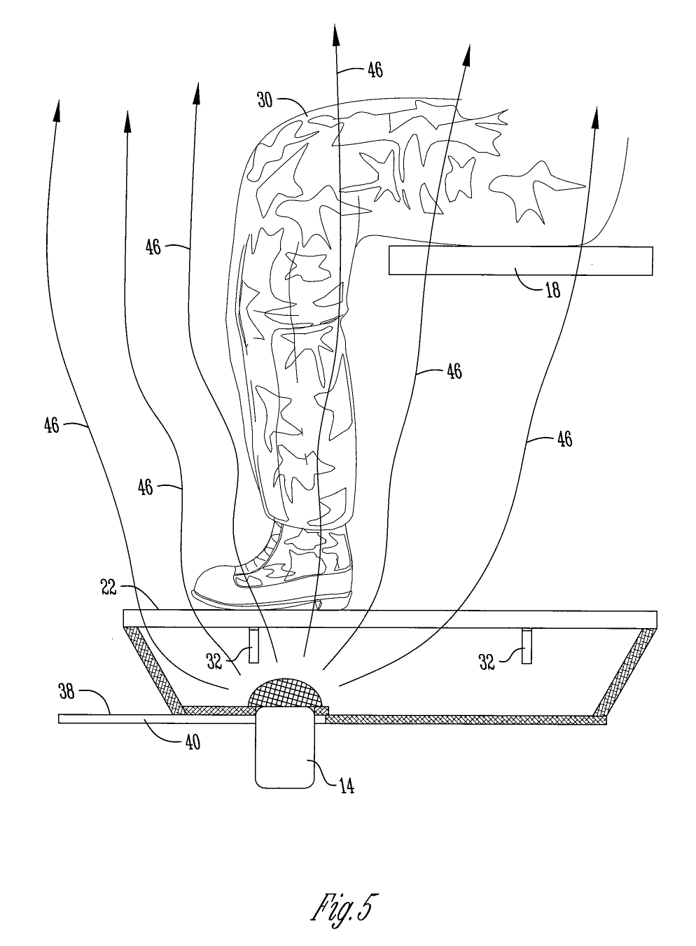

FIG. 2 shows a plan view of the heat shield/heater holder combination 14. Looking into the formed plenum 44. It can be stamped from a single sheet of heat duct material, such as tin or the like for the embodiment of FIG. 5. When attached to the bottom 24 of the tree stand as illustrated in FIGS. 1 and 5 it defines a chamber 44 with the foot platform functioning as a grate and forming the top of the heat chamber 44. When the heater 16 is turned on heat 46 rises since it is warmer than the surrounding ambient air. As the heat 46 rises, it creates an updraft carrying the human scent upward and away.

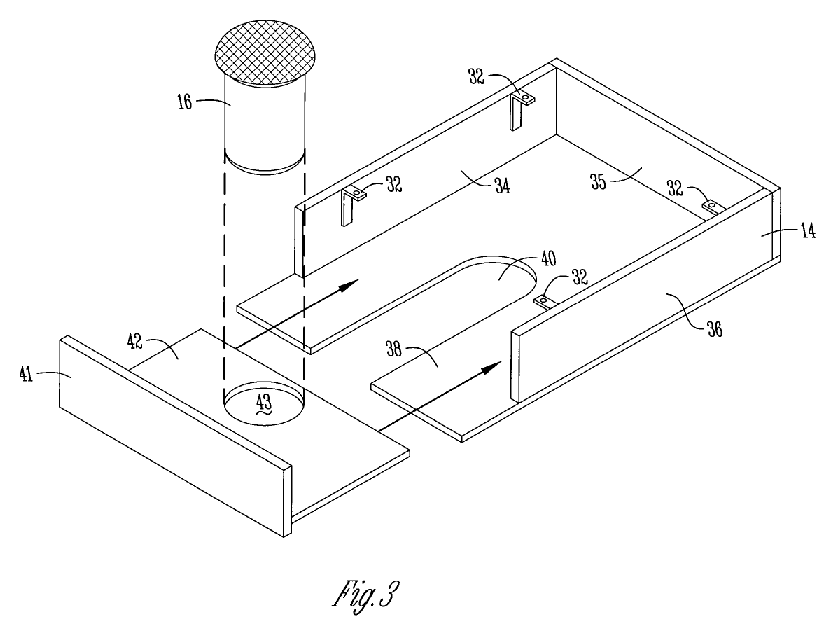

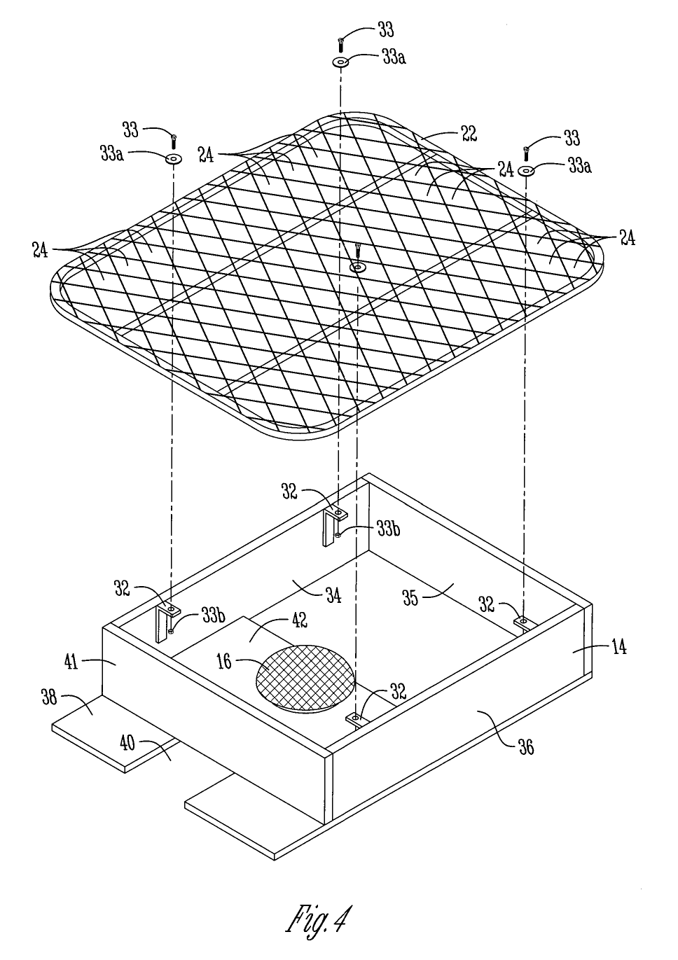

The plenum or chamber 44 defined by the heat shield and heater holder 14 and the foot support or grate 22 can be a variety of different configurations, depending upon the shape into which heat duct material is stamped. One configuration is shown in FIGS. 1-4, Another which has angular side walls 34 and 36 at angles greater than 90° and made of sheet metal is shown in FIG. 5. Either of these has their advantages depending upon the user's personal preference.

The chamber 14 can be made of tin or other conventional heat duct sheet metal material. It may even be possible to use heat-resistant polymeric plastic material for light weight control, but metal or the wooden chambers as illustrated are satisfactory. For ease of manufacture injection molded plastic may be preferred.

Conventional fasteners and brackets may be used as illustrated but one can use rivets, screws, bolts, welding, or even a slide rail in the bottom of platform 22 to allow a chamber to simply slide into longitudinal slots formed in the bottom of foot support 22. Also it is possible to attach to a surface of the plenum 14, support holders for a camouflage framework to surround the tree stand 12.

In actual operation it can be seen that when the heater 16 is operated hot air inside of the chamber defined by the heat shield and propane heater holder 14 rises through the grate 22 holes 24 of the support and upward and around the hunter via directional arrows 46. As it does so the updraft takes the human scent up and away. As a result, the scent rising with the naturally rising hot air is swept away from the hunter, up where it catches the prevailing winds and moves away. Therefore, the scent does not move downward to the ground area where the deer are moving through. They therefore fail to smell the hunter.

It therefore can be seen that the invention accomplishes at least its stated primary objective.

What is claimed is:

1. A method of controlling human scent from hunters in tree stands, comprising:
providing a deer tree stand having a vented foot platform with a combination heat shield and heater holder selectively attachable to the bottom of the foot platform to define a plenum;
placing a portable heater in the heater holder; and
operating the heater whereby warm air and along with it human scent rises and is directed by the heat shield upward passed the hunters body.

2. The method of claim 1 wherein the heater is a propane heater.

3. The method of claim 1 wherein the heater is a butane heater.

4. The method of claim 1 wherein the heat shield has support holders for camouflage rods to allow a camouflage framework to be built around the tree stand.

5. The method of claim 1 wherein the combination heat shield and heater holder that defines a plenum under the vented foot platform, has an opening to hold the rim of a gas heater.

6. The method of claim 5 where the plenum has sidewalls angled 90°.

7. The method of claim 6 wherein the plenum has sidewalls angled at greater than 90°.

8. In a tree stand device having a seat for a hunter and a vented foot platform for the hunter's feet, the improvement comprising:
a detachable heat shield and heater holder, defining a plenum which when heating occurs will direct warm air and human scent with it, up and away from the hunter.

9. The tree stand device of claim 8 wherein the detachable heat shield and heater holder attaches to the bottom of the vented foot holder by conventional fasteners.

10. The tree stand device of claim 9 wherein the detachable heat shield and heater slides into a track in the bottom of the foot holder.

11. The tree stand device of claim 8 wherein the plenum has sidewalls angled at 90°.

12. The tree stand device of claim 8 wherein the plenum has sidewalls angled at greater than 90°.

13. In combination, an off the ground deer stand having:
a seat and a foot platform, said foot platform having air vents; and
a detachable heat shield and heater holder defining a plenum chamber under said foot platform which when heating occurs will direct hot air and human scent upward and then away from the hunter; and
a heater for detachable attachment to said heater holder.

14. The deer stand combination of claim 13 wherein the plenum chamber is comprised of a single piece of heat duct sheeting, cut and stamped to define the plenum chamber.

15. The deer stand of claim 13 wherein the plenum chamber has 90° sidewalls.

16. The deer stand of claim 13 wherein the plenum chamber has greater than 90° sidewalls.

17. The deer stand of claim 13 wherein the plenum chamber is attached to the bottom of the foot platform with conventional fasteners.

18. The deer stand of claim 13 wherein the plenum chamber slides into guide slots on the bottom of the foot platform.

19. The deer stand of claim 13 wherein the plenum chamber is made of tin.

20. The deer stand of claim 13 wherein the plenum chamber is made of heat resistant polymer plastic material.
